(19) United States
(12) Patent Application Publication
(10) Pub. No.: US 2008/0147928 A1
(43) Pub. Date: Jun. 19, 2008

(54) Transparent support of multiple bus interfaces on a device

(76) Inventors: Richard Nicolet, Menlo Park, CA (US); Remy Zimmerman, Belmont, CA (US); Arnaud Glatron, Santa Clara, CA (US); Frantz Lohier, El Cerrito, CA (US)

Correspondence Address: THE LAW OFFICE OF DEEPTI PANCHAWAGH - JAIN, C/O INTELLEVALE, PO BOX 52050, MINNEAPOLIS, MN, 55402, US

(21) Appl. No.: 11/639,718

(22) Filed: Dec. 15, 2006

Related U.S. Application Data
(60) Provisional application No. 60/849,527, filed on Oct. 5, 2006.

(51) Int. Cl. G06F 13/38

(52) U.S. Cl. 710/62

(57) ABSTRACT

A system and method for seamlessly switching between various bus interfaces on a device, regardless of the application using the device. The change of the bus interface being used is completely transparent to the application using the device. A system in accordance with an embodiment of the present invention creates a Physical Device Object (PDO) that is unique for each device, regardless of which bus interface is used by the device. An application using that is essentially linked to this unique PDO. In one embodiment, an exhaustive list of various devices connected to the different bus interfaces is created. This is done by creating a bridge between the enumerators for the various buses and a class enumerator.

### CROSS-REFERENCES TO RELATED APPLICATIONS

This application claims the benefit of, and priority under 35 USC §119(e) to, co-pending provisional application No. 60/849,527, entitled “Transparent Support of Multiple Bus Interfaces on a Device”, filed on Oct. 5, 2006, which is hereby incorporated herein in its entirety.

### BACKGROUND OF THE INVENTION

1. Field of the Invention

This invention relates generally to connecting a device to a host via multiple bus interfaces, and more particularly, to seamless and transparent switching and/or reconnecting of bus interfaces connecting the device to the host.

2. Description of the Related Art

The use of numerous peripheral devices has become pervasive over the last several years. Each host (e.g., a user's personal computer) often has several peripheral devices connected to it, as keyboards, mice, trackballs, webcams, other digital cameras, joystick and gamepads, Personal Digital Assistants (PDAs), portable media players, and so on. Each of these peripheral devices often have several bus interfaces for communicating with the host, such as a parallel port, a USB port, a wireless transceiver, and so on.

While any of such multiple bus interfaces can be used to connect the device to the host, it is not conventionally possible to seamlessly change the bus interface used to connect the device to the host, without needing to interrupt the user experience with the device (e.g., by exiting and re-entering the application using the device). For instance, consider the scenario where a user is involved in a Video Instant Messaging (VIM) conversation using an Instant Messaging application (such as Windows Live Messenger from Microsoft Corp. (Redmond, Wash.)). Let us say that the user is using a wireless webcam, in its wireless mode, for this conversation. Now imagine that the battery of the wireless webcam is about to run out, and the user decides to dock the wireless webcam in a docking station, which communicates with the user's PC via a USB bus interface. In other words, when the wireless webcam is docked, rather than communicating with the user's PC using its wireless bus interface, the webcam will communicate with the user's PC using a different bus interface (in this example, USB). Conventionally, when this bus interface changes, the on-going VIM conversation is interrupted. The user then has to re-start the VIM conversation with the other user. This is highly inconvenient and disruptive for the user. For some other applications, the user may even need to exit the application itself and restart it after a bus interface has been changed or reconnected.

It is to be noted that for several applications, even if a device is disconnected from a specific bus interface and then reconnected to the same bus interface (e.g., USB), the user experience would still be interrupted.

Some applications may permit such bus interface changing and/or reconnecting for a device, but in such cases, the ability to seamlessly switch the device bus interface is dependent on the specific application used.

There is thus a need for a seamless and transparent switching between various bus interfaces of a device, where such switching is independent of the application using the device. There is also a need for a seamless and transparent disconnection from, and reconnection to, a bus interface of a device, where such disconnection and reconnection is independent of the application using the device.

### BRIEF SUMMARY OF THE INVENTION

Embodiments of the present invention provide a system and method for seamlessly switching between various bus interfaces on a device, regardless of the application using the device. The change of the bus interface being used is completely transparent to the application using the device. Embodiments of the present invention also provide a system and method for seamlessly reconnecting a device to a host using the same bus interface.

A system in accordance with an embodiment of the present invention creates a Physical Device Object (PDO) that is unique for each device, regardless of which bus interface is used by the device. That is, the PDO created in accordance with various embodiments of the present invention is independent of the bus interface that is being used. An application using the device is connected to this unique PDO, rather than to a bus interface specific PDO. In one embodiment, a unique PDO is created for each function of each device (e.g., one PDO for audio, one PDO for video, for a device that has both audio and video functionality).

The stacks corresponding to each bus interface are monitored. In one embodiment, this monitoring is done via a mini-driver which is inserted into the enumerator for each bus interface. These mini-drivers communicate with the class enumerator. When the device uses a specific bus interface, a PDO specific to that device for that bus interface is conventionally created by a class enumerator, under a comprehensive stack. The unique PDO created in accordance with various embodiments of the present invention then links to this bus interface specific PDO. When a different bus interface is used to connect the device to the host, a new bus interface specific PDO is created. By monitoring the stack corresponding to the new bus interface, a system in accordance with some embodiments of the present invention is aware of this new PDO, and establishes a link between this new PDO and the unique PDO. Since the application is linked to the unique PDO, the bus interface specific PDOs being created and destroyed in the host do not affect the link between the application and the device. Thus the changing of the bus interface is entirely seamless and transparent.

In one embodiment, PDO specific to each function of a device are created by a group driver (e.g., a group driver provided by Microsoft). This group driver is provided the unique device PDO created by the class enumerator, and the group driver then identifies the different functions performed by the device, and creates a function specific PDO for each function of the device.

In accordance with one embodiment of the present invention, purely software bus interfaces can be created. Such software bus interfaces are useful for testing and debugging the system. Further, such software bus interfaces can fake the presence of the device even when the device is not connected to the host. Moreover, such software bus interfaces can be used to guide the user to plug a physical device when none is found.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawing, in which:

FIG. 1A is a block diagram of a prior art system showing a device connected to a host using a first bus interface.

FIG. 1B is a block diagram of a prior art system showing a device connected to a host using a second bus interface.

FIG. 2A is a block diagram which illustrates a system in accordance with an embodiment of the present invention, where a first bus interface is used to connect a device to a host.

FIG. 2B is a block diagram which illustrates a system in accordance with an embodiment of the present invention, where a second bus interface is used to connect a device to a host.

FIG. 2C is a block diagram which illustrates a system in accordance with an embodiment of the present invention, where multiple bus interfaces are simultaneously used to connect a device to a host.

FIG. 3 is a flowchart which illustrates the working of a system in accordance with an embodiment of the present invention.

FIG. 4 illustrates how an exhaustive list of the functions for each device is created in accordance with an embodiment of the present invention.

FIG. 5 illustrates an implementation in Windows of one embodiment of the present invention.

FIG. 6A is a block diagram which shows the class enumerator 630 in accordance with an embodiment of the present invention.

FIG. 6B is a block diagram which shows the class enumerator 630 in accordance with another embodiment of the present invention.

FIG. 7 illustrates two options available to make the bridge between a wireless bus interface and the multi-media software stack, in accordance with an embodiment of the present invention.

### DETAILED DESCRIPTION OF THE INVENTION

The figures (or drawings) depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein. It is to be noted that the term “bus interface” is used herein to represent a way of connecting a device to a host. For instance, examples of bus interfaces include Wi-Fi, USB, IEEE 1394, and so on. The terms “ports” are sometimes used interchangeably with the term “bus interface” (when referring, for example, to a USB port on a device). The terms “buses” and “bus interfaces” are also used to refer to similar concepts (e.g., the USB bus in a host). In addition, it is to be noted that while a webcam with specific bus interfaces is used as an example of a peripheral device in parts of the ensuing discussion, the various embodiments of the present invention are equally applicable to other peripheral devices and other bus interfaces.

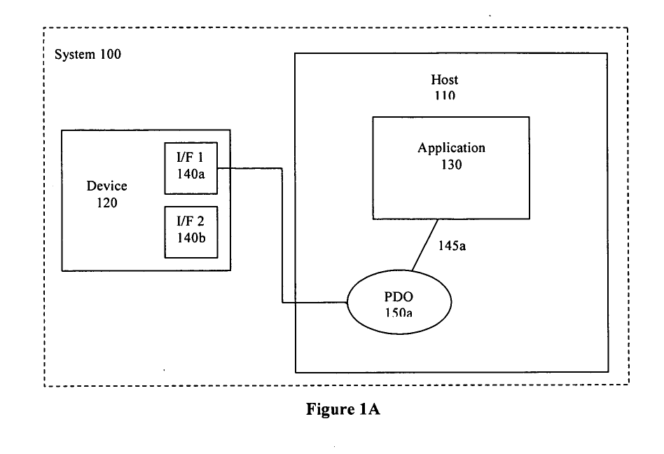

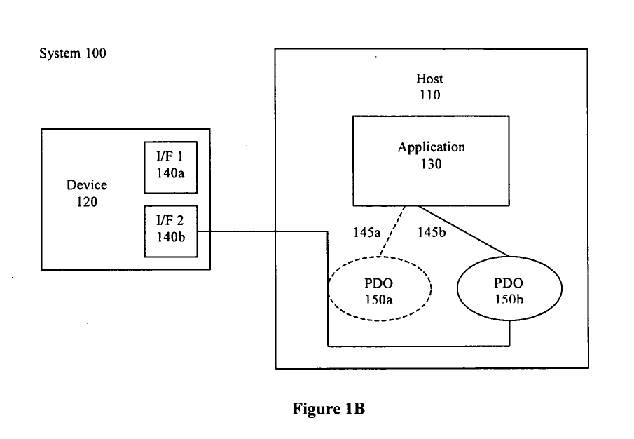

FIG. 1A is a block diagram of a prior art system. The system 100 includes a host system 110, a device 120, and an application 130 using the device 120.

In one embodiment, the host system 110 is a conventional computer system (e.g., a user's PC), that may include a computer, a storage device, a network services connection, and conventional input/output devices such as, a display, a mouse, a printer, and/or a keyboard, that may couple to a computer system. The computer also includes a conventional operating system, an input/output device, and network services software. In addition, in some embodiments, the computer includes Instant Messaging (IM) software for communicating with an IM service. The network service connection includes those hardware and software components that allow for connecting to a conventional network service. For example, the network service connection may include a connection to a telecommunications line (e.g., a dial-up, digital subscriber line (“DSL”), a T1, or a T3 communication line). The host computer, the storage device, and the network services connection, may be available from, for example, IBM Corporation (Armonk, N.Y.), Sun Microsystems, Inc. (Palo Alto, Calif.), or Hewlett-Packard, Inc. (Palo Alto, Calif.). It is to be noted that the host system 110 could be any other type of host system such as a PDA, a cell-phone, a gaming console, or any other device with appropriate processing power.

The device 120 is any device that can be connected to the host system 110 using one or more of several bus interfaces. For instance, the device 120 can be an input device such as a mouse or keyboard, such as those from Logitech, Inc. (Fremont, Calif.). The device 120 can also be a digital camera or a webcam, again such as those from Logitech, Inc. (Fremont, Calif.). Other examples of device 120 include a Personal Digital Assistant (PDA), a cellphone, a joystick, game-pad, and so on.

In FIG. 1A, it can be seen that the device 120 has two bus interfaces, I/F1 140a, and I/F2 140b. One (or both) of these bus interfaces can be used to connect the device 120 to the host 110. These bus interfaces 140a and 140b can be one of any bus interfaces such as, but not limited to, Universal Serial Bus (USB) (1.1, 2.0, etc.), FireWire (also known as iLink or IEEE 1394), serial bus interface, parallel bus interface, and various wireless bus interfaces (using technologies such as Bluetooth, RF, IR, etc.), and so on. There are ports corresponding to these various bus interfaces in the device 120 as well as in the host 110, such as USB ports, FireWire bus ports, serial ports, parallel ports, and wireless ports. Wireless communications also often take place by using wireless transceivers (e.g., WiFi dongles) on the device and/or the host. In FIG. 1A, it can be seen that I/E1 140a is used to connect the device 120 to the host 110.

The application 130 can be any application using the device 120. As an example, if the device 120 is a webcam, then the application 130 can be an Instant Messaging (IM) application. Several IM programs are currently available, such as ICQ from ICQ, Inc., America OnLine Instant Messenger (AIM) from America Online, Inc. (Dulles, Va.), MSN® Messenger and Windows Live Messenger from Microsoft Corporation (Redmond, Wash.), Yahoo!® Instant Messenger from Yahoo! Inc. (Sunnyvale, Calif.), and Skype from Skype (Luxembourg).

It can be seen from FIG. 1A that when the device 120 is connected to the host 110 via I/F1 140a, a Physical Device Object (PDO) 150a is created in the host 110, and the application 130 forms a link 145a to this PDO. Conventionally, this PDO 150a is specific to the bus interface I/F1 140a. Thus, as can be seen in FIG. 1B, when I/F1 140a is disconnected, and the device connects to the host using I/F2 140b, a new PDO 150b is created. The application 130 needs to then disconnect from PDO 150a (which continues to exist as a mere shell), and connect via link 145b, to PDO 150b instead. Generally speaking, the application 130 cannot disconnect from PDO 150a and reconnect to PDO 150b seamlessly. In many situations, such a switch in the bus interface (from 140a to 140b) results in the user having to exit the application 130, restarting it, and then selecting device 120 for use with it again. In some cases, a switch in bus interface may not necessitate exiting and restarting the application, but interrupts the user experience nonetheless. The same may be true even if the user disconnects the device 120 from the host 110 and reconnects the device 120 to the host 110 using the same interface. For instance, consider that a user has connected a webcam to a PC using a USB connection, and is engaged in a video IM conversation using that webcam and the Windows Live Messenger application from Microsoft Corp. (Redmond, Wash.). If the user disconnects the USB connection, and reconnects it again, the user has to effectively re-initiate the video IM conversation. In other words, the Video IM conversation does not seamlessly continue if the user disconnects the device and then reconnects it (using the same or a different interface) with most applications today. This happens because a change of bus interface (or even a reconnection to the same bus interface) requires a switch of PDO—for instance, when switching from I/F1 140a to I/F2 140b, the application needs to disconnect from the current PDO 150a, and connect to another PDO 150b in order to reestablish the communication.

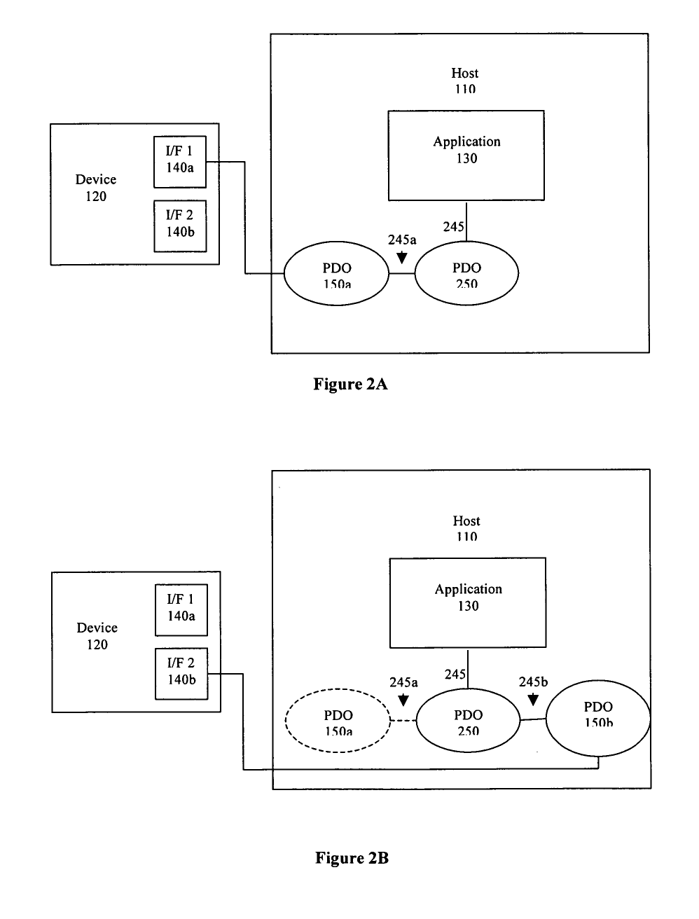

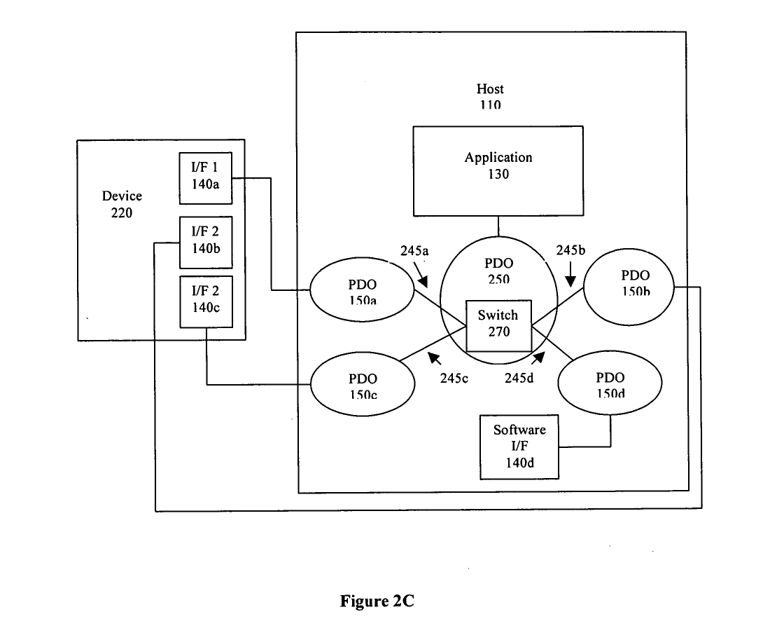

FIG. 2A is a block diagram which illustrates a system in accordance with an embodiment of the present invention. As in FIGS. 1A & 1B, it can be seen in FIG. 2A also that when device 120 connects to host 110 via I/F1 140a, a bus interface-specific PDO 150a is created in the system. Similarly, it can be seen in FIG. 2B that when device 120 connects to host 110 via I/F2 140b, a bus interface-specific PDO 150b is created in the system. However, in FIGS. 2A & 2B, it can be seen that unlike in FIGS. 1A & 1B, the application 130 does not connect to PDO 150a and/or PDO 150b. Instead, a new PDO 250 is created in accordance with and embodiment of the present invention. This PDO 250 is not bus interface specific. Rather, in one embodiment, a unique PDO 250 is created, regardless of the bus interface used, for each device 120.

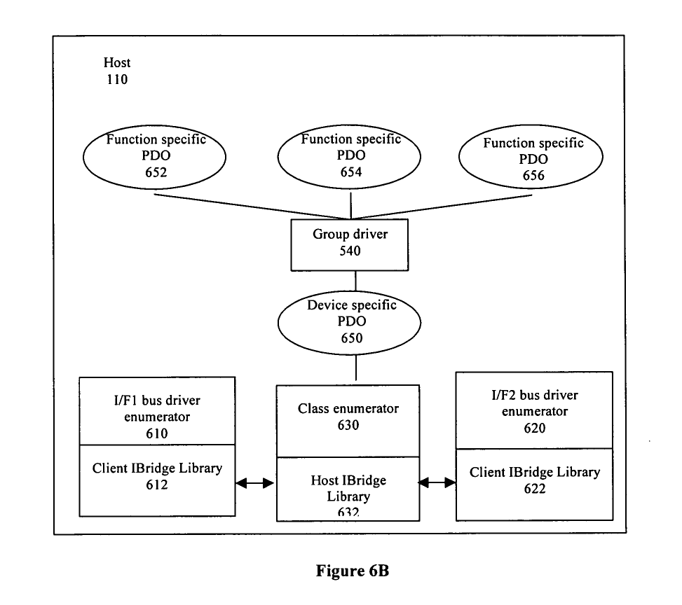

In one embodiment, a unique PDO is created for each function of device 120. Thus in a situation where device 120 is capable of performing more than one function, this will result in one unique PDO per function of the device 120. For instance, consider an example where device 120 is a webcam which is capable of performing both video and audio functions. Then one unique PDO is created for the video function of webcam 120, and one unique PDO is created for the audio function of webcam 120 in accordance with an embodiment of the present invention. In one embodiment, such unique PDOs for each function of a device are created after a unique PDO has been created for each device. This device specific PDO is then provided to a group driver, which identifies the various functions performed by the device, and creates a unique PDO for each function of the device. This is explained in more detail with reference to FIG. 6. For purposes of FIGS. 2A & 2B, we will assume that device 120 has a single function, and thus a single unique PDO 250 is created for device 120.

As can be seen from FIG. 2A, the application 130 connects, via link 245, to the unique PDO 250 regardless of the bus interface used. When I/F1 150a is used to connect device 120 to host 110, the bus interface-specific PDO 150a is created and a link 245a is formed between the unique PDO 250 and the bus interface-specific PDO 150a. Therefore, when the device 120 switches from I/F1 140a to I/F2 140b, a link is merely established between the unique PDO 250 and the newly created bus interface-specific PDO 150b, as seen in FIG. 2B. The link from application 130 to the PDO 250 remains unbroken. Conventionally, when the device no longer uses I/F1 140a to connect to the host 110, the PDO 150a remains in the host 110, but is not live/active. This is indicated by the dashed lines in FIG. 2B.

FIG. 2C illustrates another embodiment of the present invention. In this embodiment, rather than switching from one bus interface to another (as discussed above with reference to FIGS. 2A & 2B), the device 220 is connected to the host 110 simultaneously using multiple interfaces. This could happen, for instance, when a device equipped with a Wi-Fi dongle is also connected via USB to a host 110—in such a situation, the device could be connected to the host simultaneously via both the wireless interface and the wired USB interface. In such a situation, the PDO corresponding to each of these interfaces is live/active.

Referring to FIG. 2C, device 220 is shown to have three interfaces I/F1 140a, I/F2 140b, and I/F3 140c. All these interfaces are used simultaneously to connect device 220 to host 110. Each of these connections creates its own PDO 150a, 150b, and 150c respectively in the host 110. In addition, another PDO 150d is shown in FIG. 2C. This corresponds to a purely software interface that is created in accordance with an embodiment of the present invention.

Such a purely software bus interface can be created in a system in accordance with an embodiment of the present invention. One use of such a software bus interface is in testing/debugging the system. Multiple such bus interfaces could be created. For example, Tst1 140d and Tst2 (not shown) may be software bus interfaces to develop and debug sections of the comprehensive stack without any hardware. For instance, the Tst1 140d and Tst2 (not shown) bus interfaces could simulate video and audio data. By utilizing such purely software interfaces (e.g., Tst1 140d), the device 220 can be switched very easily and dynamically from run mode to test mode, without removing any parts, changing codes, changing entries in the registry, etc., simply by effectively changing the interface being used. This switch to a pure software interface 140d can be done by engineers during the testing/debugging of the device. This can also be done by the user in software if needed.

In one embodiment, the actual presence of the device (connection of the device to the host) can be “faked” by having a test interface 140d which is always connected. In one embodiment, this is accomplished by creating this software interface 140d when the device 220 software is initially installed on the host, and then keeping the software interface 140d connection on, regardless of whether or not the device 220 is actually connected to the host 110. Thus the connection from the application to the unique PDO 250 always remains unbroken, even when the device 220 is not connected to the host 110. This again serves to provide the user with a seamless experience. For example, if a user starts an IM conversation, and then realizes that he has forgotten to connect the webcam, he can simply plug the webcam in and continue the IM session, rather than having to exit the IM session and restarting it.

Referring back to FIG. 2C, it can be seen that unlike FIG. 2B where only one PDO 150b is alive/active, here numerous PDOs 150a, 150b, 150c, and 150d are alive/active. PDO 250 is simultaneously connected to, or bridged to, these several active/alive PDOs. In accordance with one embodiment of the present invention, PDO 250 includes some intelligence to determine which of these underlying various PDOs 150a, 150b, 150c, and 150d the application 130 should connect to. The switch 270 serves, in one embodiment, to connect to the appropriate underlying PDO.

In one embodiment of the present invention, the appropriate underlying PDO is determined by assigning priorities to the various bus interfaces. Table 1 provides an example of such priorities.

TABLE 1

| Bus ID | Priority |
|---|---|
| USB2 | 1 |
| WiFi | 2 |
| Test | 3 |

The priority list can grow or shrink whenever a bus interface is added to, or removed from, a particular device. It can be seen from Table 1 that a particular priority is attached to a specific bus ID. A PDO corresponding to a bus interface with a higher priority is selected, in one embodiment, via the switch 270 in FIG. 2C. In one embodiment, the priority for each bus interface can be controlled through a private bus interface, such as the bus interface “Test” shown in Table 1.

In one embodiment, each bus interface has a unique priority. If a device is connected to a host 110 via multiple bus interfaces at the same time, only one of these bus interfaces is active at any given time. Based on the priority list, the bus interface with the higher priority will be selected to be the underlying PDO in FIG. 2C. In one embodiment, the priority list can be controlled by software and can be changed dynamically.

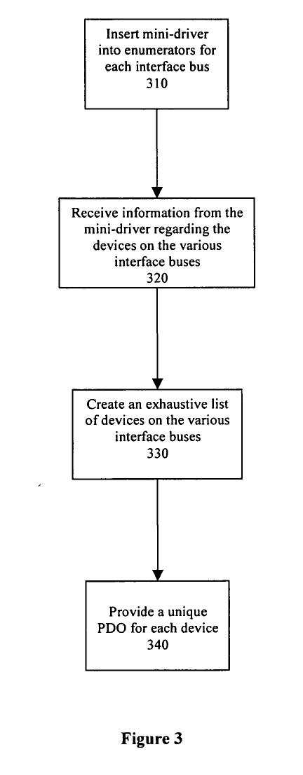

FIG. 3 is a flowchart which illustrates the working of a system in accordance with an embodiment of the present invention. When a device 120 is connected to a host 110, in accordance with an embodiment of the present, mini-drivers are inserted (step 310) into the enumerators for each bus interface on the host 110. A class enumerator 630 receives (step 320) information from each of these mini-drivers regarding which devices are present on each bus interface bus. (The class enumerator is discussed further below with reference to FIG. 6). An exhaustive list of these devices is created (step 330). A unique PDO is provided (step 340) for each device. This unique PDO for each device is then used to identify the various functions performed by the device, and a separate PDO is created for each function of the device.

In alternate embodiments, the class enumerator receives information from each of the mini-drivers regarding which functions for which devices are present on each bus interface on the host 110. In one such embodiment, the class enumerator itself creates function specific PDOs for each device.

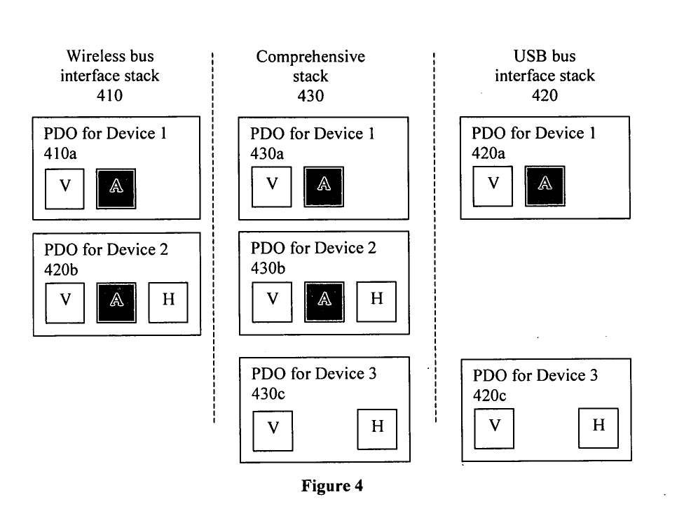

FIG. 4 illustrates how an exhaustive list of devices is created (step 330) in accordance with an embodiment of the present invention. A list of devices connected to the host via two different bus interfaces—a wireless bus interface stack 410 (e.g., used by a WiFi dongles) and a USB bus interface stack 420—are shown. The devices shown—Device 1, Device 2, and Device 3—are capable of various functions. In FIG. 4, “V” represents a video function, “A” represents an audio function, and “H” represents an HID function. Device 1 is capable of video and audio functions, Device 2 is capable of video, audio and HID functions, and Device 3 is capable of video and HID functions. It is to be noted that the specific bus interfaces, particular devices and particular functions shown in FIG. 4 are merely examples.

A system in accordance with embodiments of the present invention may include many varied bus interfaces, devices and functions. In accordance with one embodiment of the present invention, a bi-directional control pipe for each device, and an interrupt line for each function, needs to be present. In general, at least one control pipe is present on devices. The interrupt line may or may not be present. If it is present, the existing interrupt line is used, in accordance with an embodiment of the present invention, to multiplex software generated event with events from the device. If the interrupt line is not present, a system in accordance with an embodiment of the present invention will create an interrupt line over which software generated events will travel.

It can be seen from FIG. 4 that the comprehensive stack 430 is a list of devices from all bus interfaces supported, and is an exhaustive list of devices connected to the host. In FIG. 4, it can be seen that if a device is detected on multiple bus interfaces only one will be present in the comprehensive stack 430. For example, Device 1 is connected to the host using both the wireless bus interface 410 (as PDO 410a) and the USB bus interface 420 (as PDO 420a), since it is found in both these stacks. The comprehensive stack 430 lists the video and audio functions of Device 1 only once (as 430a), since it recognizes that although it is connected via two different bus interfaces, Device 1 is a single device. It can also be seen in FIG. 4 that if a device is present only in one stack, it is also added to the list. For example, Device 2 is connected to the host via the wireless bus interface 410 alone (as 410b), and is included in the comprehensive stack 430 (as 430b). Device 3 is connected to the host via the USB bus interface 420 (as 420c), and is included in the comprehensive stack 430 (as 430c).

In one embodiment, to be able to create an exhaustive list of devices in the comprehensive stack, the system needs to be able to identify each device in a unique way. In one embodiment, this is done by using a serial number from the device. Devices with a serial number can be moved from one port to another, and the device ID for every device stays the same. An example of the format of a device ID for uniquely identify a device is provided in Table 2.

TABLE 2

| Vendor ID | Product ID | Serial # |
|---|---|---|
| (8) | (8) | (38) |
| VID_xxxx | PID_xxxx | GUID |
| VID_046D | PID_0892 | |

An example of a device connected through a wireless bus interface is: L“VID_{—}046D&PID_{—}1234&{0C043139-BEEB-4e72-9E00-A166E6ED840A}”. As can be seen from Table 2, the device ID remains the same regardless of the bus interface used to connect the device, and is unique on the system. When the class enumerator 630 scans the current device list, it looks for a match of the device ID. If a match is found in the current list of devices, no new PDO is created. Instead, only the bus interface list will be updated to reflect the new bus interface. This ensures only one entry per device in the class enumerator 630.

As mentioned above, one important feature of some embodiments of the present invention is that the switch between bus interfaces is transparent to the application 130. In general, applications make a connection to the PDO once they open the device. To make the switch of bus interface seamless, this PDO to which the application 130 is connected must remain the same as long as the application is connected to it. As discussed above with reference to FIGS. 2A, 2B, 2C and 3, the class enumerator 630 creates a unique PDO 250 for each function of a device when at least one bus interface reports the presence of the function of the device. If multiple bus interfaces expose the same device, only one PDO will be created per function that the device supports.

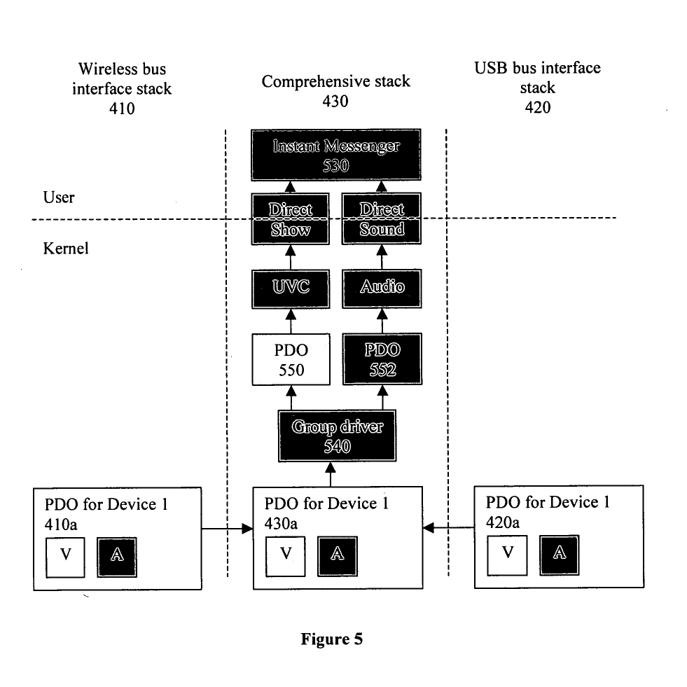

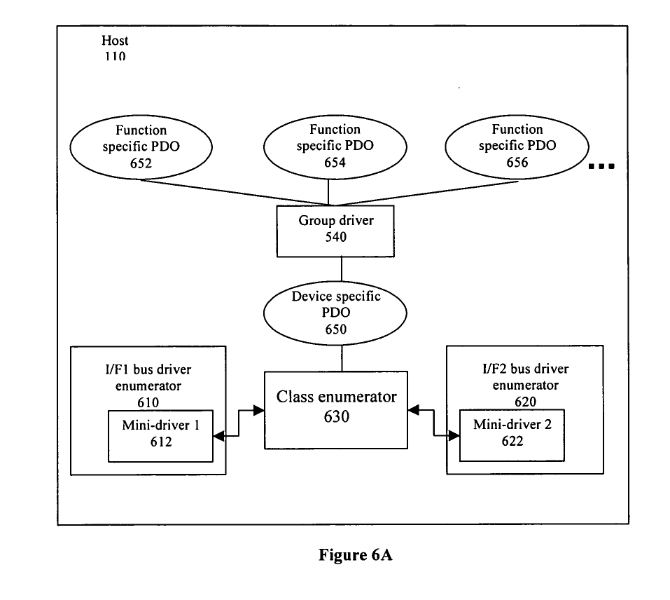

FIG. 5 illustrates an implementation in Windows of one embodiment of the present invention. Device 1 is connected to the host 110 via two different interfaces—the wireless bus interface, and the USB bus interface. Conventionally, a PDO is created for each bus interface, respectively 410a and 420a. In accordance with an embodiment of the present invention, the comprehensive stack creates only one unique PDO 430a, and reroutes the data to the conventional PDOs.

As can be seen from FIG. 5, above the device PDO 430a is loaded the group driver 540. In one embodiment, this group driver 540 is usbccgp.sys, provided in Windows by Microsoft Corp. This group driver 540 knows all functions performed by the device, and the group driver 540 creates a single unique PDO per function. Each of these function specific PDOs have their device ID. In this example, the device performs video and audio functions. Thus the group driver 540 uses the unique PDO 430a created by the class enumerator, and creates two unique function specific PDOs for the device—one PDO for video 550, and one PDO for audio 552. These function specific PDOs 550 and 552 are then linked to the application 530 (e.g., an Instant Messaging application), through some intermediate layers (e.g., UVC and DirectShow in the case of video, and Audio and DirectSound in the case of audio).

In one embodiment, the unique PDO 430a is alive as long as at least one bus interface report the presence of Device 1, or the application, which in this example is an IM application 530, is connected to one of the PDOs 550 and 552. For example if both bus interfaces in FIG. 5 notify that the device has been removed but the application 530 is still connected to the PDOs 550 and 552, they would stay alive. When the same device 1 is reconnected to the same host, the system reuses the existing PDOs 550 and 552, and continues the transmission of data when ready. In one embodiment, the IM application 530 does not need to reconnect to the device 1. Thus Device 1 being disconnected and reconnected will appear to the IM application 530 as though the transmission has simply been paused and then resumed.

The unique PDOs 430a, 550 and 552 are removed when all bus interfaces registered to the class enumerator 630 report that Device 1 is not present, and the IM application 530 is not connected to the PDOs 550 and 552.

As mentioned above, in one embodiment, the group driver 540 is that provided by Windows from Microsoft. In one embodiment, in order to use this group driver, the device ID needs to be altered. An example of such an altered device ID is provided in Table 3.

TABLE 3

| Vendor ID | Product ID | Interface ID | Serial # |
|---|---|---|---|
| (8) | (8) | (5) | (38) |
| VID_xxxx | PID_xxxx | MI_xx | GUID |
| VID_046D | PID_0892 | MI_00 | |
| | | MI_01 | |

Like the device ID provided in Table 2, this is also an example of a device connected through the wireless bus interface: L“USB\\VID_{—}046D&PID_{—}1234&MI_{—}00&{0C043139-BEEB-4e72-9E00-A166E6ED840A}”. Some differences can be seen if this modified device ID is compared with the unmodified device ID, which are italicized above. The bus information has been added as well as the interface number. The modified device ID starts with USB\., even though in this case the device is connecting through the Wi-Fi network adapter (wireless bus interface). This is needed in order to use the group driver for Windows from Microsoft to parse the device and configuration descriptor. In addition, the interface ID is also included.

FIG. 6A is a block diagram which shows the class enumerator 630 in accordance with an embodiment of the present invention. The class enumerator 630 is present in a system in accordance with an embodiment of the present invention as a class driver. Mini-driver 1 612 and min-driver 2 622 are inserted into the enumerators 610 and 620 for I/F1 and I/F2 respectively. These mini-drivers 612, 622 create a bridge to the class enumerator. The mini-drivers 612, 622 communicate with the class enumerator 630, to initially register the various I/F enumerators 610, 620, and then to provide the current list of devices per the I/F enumerators 610 and 620 to the class enumerator 630. In one embodiment, a plug & play callback is set up to notify the class enumerator 630 when devices are added or removed on any of the bus interfaces.

In accordance with an embodiment of the present invention, when a device is enumerated on a bus, the bus interface enumerator (e.g., 610, 620) will collect the device description. This device description is reported to the class enumerator 630, which creates the device specific unique PDO 650 (if it is not present in the exhaustive list). The group driver 540 loaded above the PDO 650 collects configuration description and analyzes it to create the appropriate function specific PDOs (652,654,656) for each function performed by the device. These function specific PDOs 652, 654, 656 are in turn linked to applications 130.

FIG. 6B is a block diagram which shows the class enumerator 630 in accordance with another embodiment of the present invention. The functionality of the class enumerator is very similar to that described with reference to FIG. 6A above. Examples of bus enumerators 610 and 620 include USB and network intermediate drivers. Here, however, rather than mini-drivers being inserted into the bus enumerators 610, 620, client libraries 612, 622 are inserted into the bus enumerators 610, 620 respectively. These client libraries 612, 622 provide a bridge to the host library 632, which is on the class enumerator 630.

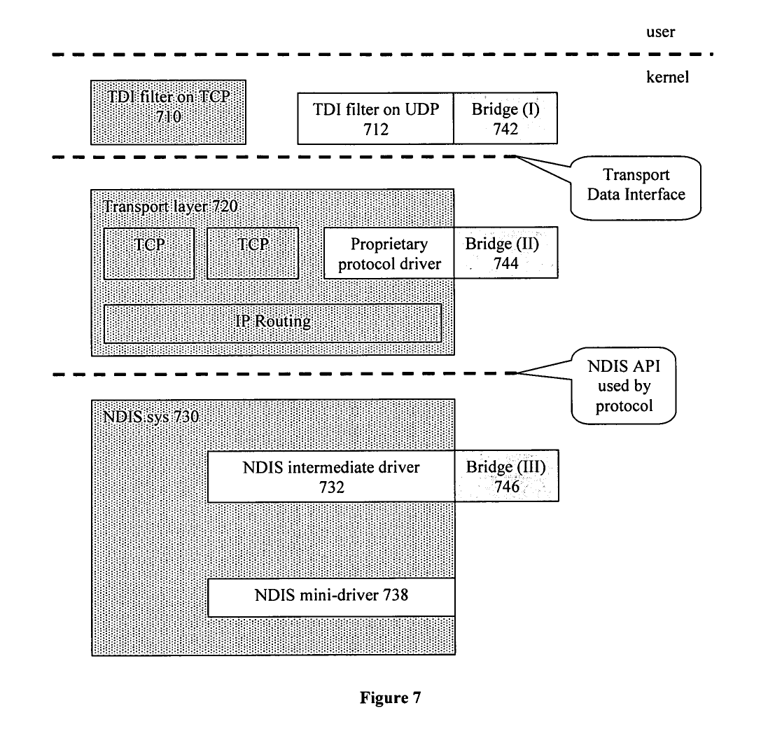

FIG. 7 illustrates two options available to make the bridge between a wireless bus interface and the multi-media software stack in accordance with an embodiment of the present invention.

The TDI filter 710, the Transport Layer 720, and the NDIS.sys 730 are operating system components. The TDI filter 710 is optional. The NDIS.sys 730 can be a Microsoft NDIS library. The NDIS mini-driver 738 is for the wireless bus interface. An example of the NDIS min-driver 738 is a Wi-Fi dongle, such as those provided by Marvell Semiconductor, Inc. (Santa Clara, Calif.). The TDI filter on UDP 712, and the NDIS intermediate driver 732, are possible options where the wireless bus interface stack from the network can be bridged to the to multi-media stack.

In one embodiment, bridge 1742 at the TDI level is implemented. This has the advantages of reusing existing infrastructure, and of being able to use the wireless bus interface stack for developing and debugging. Moreover, this is a well-defined protocol and it is easy to verify the correct implementation using standard software solutions. In another embodiment, bridge II 744 at the Transport Layer 720 is implemented. In yet another embodiment, bridge III 746 at the NDIS level is implemented. This has the advantages of not needing to register the wireless dongle as a network device.

While particular embodiments and applications of the present invention have been illustrated and described, it is to be understood that the invention is not limited to the precise construction and components disclosed herein. For example, portions of various embodiments of the present invention can be implemented in the user mode or in the kernel mode. As another example, libraries can be used in place of mini-drivers inserted into the interface bus driver enumerators. Various other modifications, changes, and variations which will be apparent to those skilled in the art may be made in the arrangement, operation and details of the method and apparatus of the present invention disclosed herein, without departing from the spirit and scope of the invention as defined in the following claims.

What is claimed is:

1. A method for providing transparent support of a plurality of bus interfaces, where a device is communicatively coupled to a host using at least one of the plurality of bus interfaces, the method comprising:
creating a unique physical device object (PDO) for the device, regardless of the one of the plurality of bus interface used to couple the device to the host.

2. The method of claim 1, further comprising:
creating a unique function specific PDO for each function performed by the device.

3. The method of claim 2, further comprising:
in response to an application accessing a function of the device, linking the application to the unique function specific device PDO.

4. The method of claim 1, further comprising:
creating an exhaustive list of a plurality of devices coupled to the host using the plurality of bus interfaces.

5. The method of claim 4, wherein the step of creating an exhaustive list comprises:
inserting a mini-driver into an enumerator for each of the plurality of bus interfaces on the host;
receiving information from each of the plurality of mini-drivers regarding each device enumerated by a corresponding one of the plurality of enumerators.

6. A method for seamlessly connecting a device to a host via at least one of a plurality of bus interfaces, the method comprising:
installing a class enumerator on the host;
inserting a plurality of mini-drivers in a plurality of enumerators, wherein each of the plurality of enumerators corresponds to one of the plurality of bus interfaces;
creating a bridge from each of the plurality of mini-drivers to the class enumerator;
providing information over each of the plurality of bridges regarding whether the device is connected to the host via the corresponding bus interface.

7. The method of claim 6, further comprising:
creating a unique PDO for the device.

8. The method of claim 7, further comprising:
linking the unique PDO to an application using the device.

9. The method of claim 6, wherein the device performs a plurality of functions, the method further comprising:
creating a unique function specific PDO for each of the plurality of functions of the device.

10. The method of claim 9, further comprising:
linking an application using one of the plurality of functions to the corresponding unique function specific PDO.

11. A system for seamless connection of a device to a host, wherein the device has a first bus interface and a second bus interface for connecting to the host, the system comprising:
a class enumerator;
a first enumerator for the first bus interface;
a second enumerator for the second bus interface;
a first bridge from the first enumerator to the class enumerator; and
a second bridge from the second enumerator to the class enumerator.

12. The system of claim 11, wherein the first bridge comprises a mini-driver inserted into the enumerator, and wherein the second bridge comprises a second mini-driver inserted into the second enumerator.

13. The system of claim 11, further comprising:
a unique PDO for the device created by the class enumerator.

14. The system of claim 13, further comprising:
an application using the device, communicatively coupled to the unique PDO.

15. The system of claim 11, wherein the device performs a plurality of functions, further comprising:
a unique PDO for each function of the device created by a group driver.

16. The system of claim 15, further comprising:
an application using one of the plurality of functions of the device, communicatively coupled to the corresponding unique PDO.

17. The system of claim 11, wherein the first bridge comprises a library inserted into the enumerator, and wherein the second bridge comprises a second library inserted into the second enumerator.
